(19) United States
(12) Patent Application Publication
(10) Pub. No.: US 2017/0006901 A1
(43) Pub. Date: Jan. 12, 2017

(54) STABLE SUSPENSION OF A STEVIOL GLYCOSIDE IN CONCENTRATED SYRUP

(71) Applicant: CARGILL, INCORPORATED, Wayzata, MN (US)

(72) Inventors: Ting Liu Carlson, Marietta, SC (US); Aron Broman ERICKSON, Boulder, CO (US)

(73) Assignee: Cargill, Incorporated, Wayzata, MN (US)

(21) Appl. No.: 15/113,705

(22) PCT Filed: Jan. 29, 2015
(86) PCT No.: PCT/US2015/013457

§ 371 Date: Jul. 22, 2016

Related U.S. Application Data
(60) Provisional application No. 61/933,059, filed on Jan. 29, 2014.

(51) Int. Cl. A23L 2/68; A23L 2/60; A23L 2/56; A23L 2/385

(52) U.S. Cl. CPC A23L 2/68; A23L 2/385; A23L 2/60; A23L 2/56; A23V 2002/00

(57) ABSTRACT

A method is provided for preparation of a syrup or concentrate containing one or more stable suspensions of steviol glycosides comprising the steps of: adding one or more steviol glycosides to an aqueous solution to provide a steviol mixture; adjusting the pH of the steviol mixture at ambient temperatures to a pH in a range of about 7-9; then again adjusting the pH of the steviol mixture, with a sufficient amount of an acidic aqueous solution, to a pH in a range of about 2-4 to provide a liquid beverage concentrate containing a stable suspension of one or more solid steviol glycoside particles having a size of about 10-80 um long and 0.1-2 um thick, and having a concentration of up to about 1000-3000 ppm. Syrup or concentrate compositions are also provided.

### CROSS REFERENCE TO RELATED APPLICATION

This application claims the benefit of the U.S. Provisional Patent Application, Ser. No. 61/933,059, filed Jan. 29, 2014, entitled STABLE SUSPENSION OF A STEVIOL GLYCOSIDE IN CONCENTRATED SYRUP, which is hereby incorporated by reference in its entirety.

### FIELD OF THE INVENTION

The present invention relates to steviol glycosides. More specifically, the present invention relates to providing stable suspensions of steviol glycosides in a concentrated syrup.

### BACKGROUND OF THE INVENTION

Sugar alternatives are highly sought after for use in various food and beverage products. Steviol glycosides are sweet-tasting compounds extracted from the stevia plant (Stevia rebaudiana Bertoni) that are of particular interest.

U.S. Pub. No. 2013/0189399 describes a liquid beverage concentrate that has an increased viscosity to improve the stability of a liquid concentrate. The concentrate includes one or more viscosity increasing agents that slow the rate of hydrolysis and oxidation.

### SUMMARY OF THE INVENTION

It has been found that the use of steviol glycosides, for example, rebaudioside B, in concentrated syrups is particularly desirable due to the resulting sweetness and flavor profile of the final products prepared from such syrups. Preparations of such concentrated syrups comprising steviol glycosides, such as rehaudioside B, are particularly challenging because the syrup must have a low pH to be properly used in most beverage applications. To incorporate steviol glycosides into a concentrated syrup, the solubility of the ingredient in the syrup should typically be about 6 times higher than its desired concentration in the finished beverage. It has been found that a stable suspension of steviol glycosides, rehaudioside B in particular, in a concentrated syrup may be prepared by the methods of the present invention.

In particular, a method is provided for preparation of a stable suspension in a liquid beverage concentrate containing rebaudioside B, in which the C₁₉-carboxylic group on the steviol backbone in rebaudioside B in a first step of the process is at least about 99% in the dissociated carboxylate form and in a second step of the process at least about 99% protonated in the carboxylic acid non-ionized form. The method comprises: adding one or more steviol glycosides to an aqueous solution to provide a steviol mixture; adjusting the pH of the steviol mixture to a pH in a range of about 7-9; then adjusting the steviol mixture with a sufficient amount of an acidic aqueous solution to a pH in a range of about 2-4 to provide a liquid beverage concentrate containing a stable suspension of one or more solid steviol. glycoside particles having of about 10-80 um long and about 0.1-2 um thick, and having a concentration of about 1000-3000 ppm.

Stable suspensions of steviol glycosides in a concentrated syrup made by the present method are particularly useful as precursors to beverages as “throw syrups” due to their stability and unique compositional profile. Surprisingly, stable steviol glycoside suspensions may be formulated utilizing the present method that have excellent flavor profiles due to the incorporation of the difficult to solubilize steviol glycoside rebaudioside B. By providing rebaudioside B as part of a stable suspension, it is possible to create a liquid beverage concentrate which includes rebaudioside B at higher concentrations than were previously possible.

The present invention additionally provides a liquid beverage concentrate comprising a stable suspension comprising one or more steviol glycosides at a concentration of at least 500 ppm. The stable suspension includes suspended particles in a size range of about 10-80 um long and 0.1-2 um thick at a pH in a range of about 2-4. In some embodiments, the particles have a needle-like crystalline shape. Such particles are referred to herein as “needles”. In certain embodiments, the stable suspension comprises substantially no needles greater than 3 um thick. In other embodiments, the stable suspension comprises no needles greater than 3 um thick.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

One embodiment disclosed herein is a liquid beverage concentrate comprising a stable suspension at a pH of about 2-4 containing one or more steviol glycoside particles in a size of about 10-80 um long and 0.1-2 um thick. In some embodiments, the one or more steviol glycosides may be at a concentration of at least 500 ppm. In other embodiments, the one or more steviol glycoside particles may be in a concentration of at least 800 ppm. In yet other embodiments, the one or more steviol glycoside particles may be in a concentration of at least 1000 ppm. In yet other embodiments, the one or more steviol glycoside particles may be in a concentration in a range of about 1000-3000 ppm. The liquid beverage concentrate may optionally include an emulsifier in a concentration of about 0.1-1 wt %.

In a preferred embodiment, the steviol glycoside is rebaudioside B. Other steviol glycoside particles may also be present; such additional particles include rebaudioside A, rebaudioside C, rebaudioside D, rebaudioside F, steviol bioside, steviol monoside, stevioside, duluoside A, rubososide, other steviol glycosides, or combinations thereof. In another preferred embodiment, the steviol glycoside is a combination of rebaudioside A and rebaudioside B. The ratio of rebaudioside A to rebaudioside B may be 10:90, 20:80, 30:70, 40:60, 50:50, 60:40, 70:30, 80:20, or 90:10, or any ranges of these ratios.

The stable suspensions may optionally include emulsifiers selected from gum arabic, a mono- and/or diglyceride ester, a sucrose ester, methylcellulose, other surfactants, or combinations thereof.

Optionally, the liquid beverage concentrate further comprises a flavorant. The flavorant may be selected from lemon, lime, orange, grape, lemon-lime, cola, root beer, peach, kiwi, and mixtures thereof.

In some embodiments, the particles have a needle-like crystalline shape. Such particles are referred to herein as “needles”. in some embodiments, the stable suspension comprises substantially no needles greater than 3 um thick. In yet other embodiments, the stable suspension comprises no needles greater than 3 um thick.

In other embodiments, the turbidity of the stable suspension, as instrumentally measured as Nephelometric Turbidity Unit (NTU), is at least 100. In other embodiments, the NTU is at least 400. In yet other embodiments, the NTU is at least 800. In yet other embodiments, the NTU is at least 1200. In yet other embodiments, the NTU is at least 1600. In yet other embodiments, the NTU is at least 1800. In yet other embodiments, the NTU is in a range of 1000 to 2500. In yet other embodiments, the NTU is in a range of 1600 to 2200. In yet other embodiments, the NTU is in a range of 1700 to 2000.

In other embodiments, the present method comprises the steps of adding one or more steviol glycosides to an aqueous solution to provide a steviol mixture; adjusting the pH of the steviol mixture to a pH greater than 7; adjusting the steviol mixture, with a sufficient amount of an acidic aqueous solution, to provide a liquid beverage concentrate with a pH of less than 4 containing a stable suspension of one or more steviol glycoside particles having a size of about 10-80 um long and 0.1-2 um thick and having a concentration of at least 500 ppm. In other embodiments, the one or more steviol glycoside particles may be in a concentration of at least 800 ppm. In yet other embodiments, the one or more steviol glycoside particles may be in a concentration of at least 1000 ppm. In yet other embodiments, the one or more steviol glycoside particles may be in a concentration in a range of about 1000-3000 ppm.

In an embodiment of the present method, the pH of the steviol mixture may be in a range of about 7-9, or in a range of about 7.5-8.5.

In another embodiment of the present method, the final pH of the concentrate may be in a range of about 2-4, or about 3.

In some embodiments of the present method, the particles have a needle-like crystalline shape. Such particles are referred to herein as “needles”. In other embodiments, the stable suspension comprises substantially no needles greater than 3 um thick. In yet other embodiments, the stable suspension comprises no needles greater than 3 um thick.

In other embodiments of the present method, the turbidity of the stable suspension, as instrumentally measured as Nephelometric Turbidity Unit (NTU), is at least 100. In other embodiments, the NTU is at least 400. In yet other embodiments, the NTU is at least 800. In yet other embodiments, the NTU is at least 1200. In yet other embodiments, the NTU is at least 1600. In yet other embodiments, the NTU is at least 1800. In yet other embodiments, the NTU is in a range of 1000 to 2500. In yet other embodiments, the NTU is in a range of 1600 to 2200. In yet other embodiments, the NTU is in a range of 1700 to 2000.

In a preferred embodiment, the steviol glycoside is rebaudioside B. Optionally, the liquid beverage concentrate contains one or more additional steviol glycosides. Examples of steviol glycosides include rebaudioside A, rebaudioside C, rebaudioside D, rebaudioside E, rebaudioside F, stevioside, rubusoside, steviolbioside, and dulcoside A, other steviol glycosides, and mixtures thereof. These additional steviol glycosides are optionally each present at a concentration of from about 10 to about 8000 ppm.

Optionally, the steviol mixture may be mixed with a sufficient amount of an acidic aqueous solution in the presence of an emulsifier. Examples of an emulsifier include gum arabic, mono- and/or diglyceride esters, sucrose esters, methylcellulose, other surfactants, and mixtures thereof. These emulsifiers are optionally present at a concentration of about 0.1-1.0 wt %.

In a final step, the pH of the beverage concentrate is lowered to a pH of less than 4 to form a stable suspension of steviol glycosides. In an embodiment, the pH is lowered to a pH range of about 2-4 to form a stable suspension of steviol glycosides. In one embodiment, the pH is lowered to a pH of about 3. In another embodiment, the pH is lowered using an aqueous acid solution where the acid is selected from the group consisting of citric acid, malic acid, lactic acid, phosphoric acid, tartaric acid, and mixtures thereof. In an embodiment, the mixing in is carried out under gentle mixing conditions at ambient temperature.

Optionally, the steviol mixture is adjusted with an acidic aqueous solution in the presence of an emulsifier.

The steviol glycoside particles may be present in a variety of shapes such as needles, ovals, cylinders, and other shapes known in the art. In a preferred embodiment, the steviol glycoside particles are in the shape of needles.

In another embodiment, a method of making a liquid beverage from a liquid beverage concentrate is provided. A liquid beverage concentrate as described herein is diluted with a liquid to provide a liquid beverage. In some embodiments, the liquid is water. In other embodiments, the liquid is carbonated water. Examples of liquid beverages include carbonated soft drinks, ready to drink teas, sports drinks, dairy drinks, yogurt-containing drinks, alcoholic beverages, energy drinks, flavored waters, vitamin drinks, fruit drinks, and fruit juices

Optionally, the stable suspensions may comprise additional ingredients, such as flavorants, preservatives, emulsifiers, colorants, nutritive sweeteners and other high intensity sweeteners, vitamins, mineral salts, and clouding agents. In an embodiment, the flavorant is selected from the group consisting of lemon, lime, orange, grape, lemon-lime, cola, root beer, peach, kiwi, and mixtures thereof.

The optional additional ingredients may be added at any stage in the process of preparation of the stable suspensions of steviol glycosides.

### EXAMPLES

Representative embodiments of the present invention will now be described with reference to the following examples that illustrate the principles and practice of the present invention.

### Example 1

A first solution of rebaudioside B was prepared at 1000 ppm by adding 50 mg rebaudioside B solid to 47.5 mL purified water. The solution was heated to 90° C. for 5 minutes to completely dissolve rebaudioside B. After heating, 2.5 mL of 1M Citrate pH 3 solution was added to the solution and mixed.

A second solution was prepared solubilizing rebaudioside B without heating. A 1% (10,000 ppm) rebaudioside B solution was prepared in water by adjusting pH with 1M NaOH to 8.1. The solution was agitated until rebaudioside B was completely dissolved and the solution was clear. 5 mL of the 1% rebaudioside B solution was added to 42.5 mL of water and mixed. 2.5 mL of 1M Citrate pH 3 solution was added to the solution and mixed to provide a final pH of about 3.1.

Both solutions were allowed to sit at room temp for 30 minutes for observation, and then placed at 4° C. overnight for observation the next day. Initially, the unheated solution of rebaudioside B precipitated first, but was soon followed by the heated solution within a few minutes. The solution of rebaudioside B that was solubilized with sodium hydroxide formed a homogeneous suspension in solution whereas the heated solution formed larger precipitates, which fell to the bottom of the vial. The suspension characteristics were again confirmed at 16 hours after holding at 4° C.

The turbidity was determined of the suspended solids in solution utilizing a Hach 2100AN Turbidimeter. The solution with the higher NTU value represents the higher amount of suspended solids. Heated rebaudioside B solution showed minimal NTU value due to precipitation of large particles to the bottom of the vial. Moreover, the heated rebaudioside B solution included many needles which had a thickness of greater than 3 um. In contrast, the unheated solution contained much smaller needles and did not have any needles that were greater than 3 um in thickness.

This result showed that very small rebaudioside B particles can be formed and suspended in water if the process includes a sequential pH adjustment step. Without the sequential pH adjustment steps, rebaudioside B particles are much larger and cannot be suspended in water.

TABLE 1

| Sample | NTU |
|---|---|
| 1000 ppm rebaudioside B Heated Solution | 12.5 |
| 1000 ppm rebaudioside B NaOH dissolved Solution | 1860 |

### Example 2

A 3% solution of steviol glycoside (rebaudioside A and rebaudioside B at 6:4 ratio) and 0.9% sodium benzoate was prepared in water. The pH of the solution was adjusted to pH 7.8 with NaOH. The solution was diluted 1:10 into a 0.05 M citric acid buffer to a final pH 3.0. The solution turned opaque immediately. 10 consecutive samples were withdrawn from the solution while it is being mixed. Each sample was diluted 6 folds with deionized water and the concentration of rebaudioside A and rebaudioside B was determined by HPLC.

A Shiseido Capcell PAK C18 column, type MGII, (5 um, 4.6×250 mm) is used for steviol glycoside analysis using a gradient as described below. The column is maintained at 55°.

| Time | 0.01M phosphate | |
|---|---|---|
| (minutes) | butter, pH = 2.6 | Acetonitrile |
| 0 | 80% | 20% |
| 5.5 | 80% | 20% |
| 8 | 70% | 30% |
| 11 | 70% | 30% |
| 14.5 | 65% | 35% |
| 23 | 65% | 35% |
| 26.5 | 20% | 80% |
| 29 | 20% | 80% |
| 31.5 | 80% | 20% |
| 33.5 | 80% | 20% |

The concentrations of rebaudioside B in 10 samples were very consistent with minimal deviation at time 0 and then after storage at 4° C. for 96 hours. The results showed a homogeneous suspension of steviol glycosides consisted of rebaudioside A and rebaudioside B and sodium benzoate can be achieved without the use of emulsifiers or additives.

TABLE 2
Concentration of rebaudioside B in homogeneous
suspension in 10 consecutive samples

| ppm | T0 | T96 |
|---|---|---|
| sample | rebB | rebB |
| 1 | 1141.11 | 1128.40 |
| 2 | 1145.52 | 1123.13 |
| 3 | 1168.59 | 1127.92 |
| 4 | 1155.58 | 1136.25 |
| 5 | 1155.97 | 1137.10 |
| 6 | 1146.48 | 1137.22 |
| 7 | 1164.88 | 1142.01 |
| 8 | 1161.56 | 1130.50 |
| 9 | 1159.74 | 1135.86 |
| 10 | 1146.85 | 1142.38 |

### Example 3

A first solution (solution A) was prepared by heating 1000 ppm of rebaudioside B dissolved in water at 90° C. for 2 minutes. The solution was cooled and mixed with 5% of 1M citric acid buffer at pH 2.0. Particles were observed in the solution under a light microscope at 400× magnification.

A second solution (solution B) was prepared by heating 1000 ppm of rebaudioside B dissolved in water at pH 7.5 at 90° C. for 2 minutes. The solution was cooled and mixed with 5% of 1M citric acid buffer at pH 2.0 and let stand for 3 hours at room temperature. Particles were observed in the solution under a light microscope at 400× magnification. The results are shown in table 3.

TABLE 3

| | | | |
|---|---|---|---|
| solution | needle length | needle thickness | presence of needles >3 um thick |

| | | | | | |
|---|---|---|---|---|---|
| A | 20-100 | um | 1-3 | um | yes |
| B | 10-60 | um | >1 | um | no |

### Example 4

A first solution (solution A) was prepared by heating 1000 ppm of rebaudioside B and 0.1 wt % gum Arabic dissolved in water at 90° C. for 2 minutes. The solution was cooled and mixed with 5% of 1M citric acid buffer at pH 2.0. Particles were observed in the solution under a light microscope at 400× magnification.

A second solution (solution B) was prepared by heating 1000 ppm of rebaudioside B and 0.1% gum Arabic dissolved in water at 7.5 at 90° C. for 2 minutes. The solution was cooled and mixed with 5% of 1M citric acid buffer at pH 2.0 and let stand for 3 hours at room temperature. Particles were observed in the solution under a light microscope at 400× magnification.

Each solution was then stored at 4° C. for 3 days without mixing.

The results are shown in table 4. Solution B formed a string-like network in the vial. Solution A separated into two phases after 3 days, while solution B remained as a homogenous suspension

TABLE 4

| | | | |
|---|---|---|---|
| solution | needle length | needle thickness | presence of needles >3 um thick |

| | | | | | |
|---|---|---|---|---|---|
| A | 20-100 | um | 2-3 | um | yes |
| B | 40-80 | um | 0.1-1 | um | no |

As seen in Table 4, needles are much smaller in solution B. In addition, solution B does not have any needles that are greater than 3 urn thick.

Example 5

A first solution (solution A) was prepared by combining 1050 ppm of rebaudioside B dissolved in water and heated to 80° C. for 3 minutes. Solution A was immediately mixed with 5% 1M citric acid at pH 3.2 and allowed to cool to room temperature for 18 hours.

A second solution (solution B) was prepared by combining 1050 ppm of rebaudioside B dissolved in water at adjusted to 8.0 pH. Solution B was mixed with 5% 1M citric acid and allowed to precipitate at room temperature for 18 hours.

Crystals were observed under a light microscope. The results are shown in Table 5. Solution A fell out of suspension and collected at the bottom of the vial, while solution B was a stable suspension fainted as a string-like network.

TABLE 5

| solution | needle length | | needle diameter | | presence of needles >3 um thick |
|---|---|---|---|---|---|
| A | 25-800 | um | Up to 12 | um | yes |
| B | 10-80 | um | 0.5-2 | um | no |

As seen in Table 5, needles are significantly smaller in solution b compared to solution A. Solution A contains extremely long needles and needles that are much thicker than that of solution B. In addition, solution B does not have any needles that are greater than 3 urn thick.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed:

1. A liquid beverage concentrate comprising:
a stable aqueous suspension at a pH in a range of about 2-4 containing one or more solid steviol glycoside particles having a size of about 10 um to about 80 um long and about 0.1 um to about 2.0 um thick at a concentration of at least 500 ppm.

2. The concentrate of claim 1, wherein the concentration of the one or more steviol glycoside particles ranges from about 1000 ppm to about 3000 ppm. The concentrate of claim 1, wherein the steviol glycoside is rebaudioside B.

4. The concentrate of claim 1 further comprising sodium benzoate.

5. The concentrate of claim 1 further comprising one or more emulsifiers at a concentration of about 0.1-1.0 wt %.

6. The concentrate of claim 5, wherein the emulsifier is gum arabic, a mono- or diglyceride ester, a sucrose ester, methylcellulose, other surfactants, or combinations thereof.

7. The concentrate of claim 1 further comprising a flavorant, wherein the flavorant is lemon, lime, orange, grape, lemon-lime, cola, root beer, peach, kiwi, and mixtures thereof.

8. The concentrate of claim 1, wherein the NTU of the suspension is at least 1200.

9. The concentrate of claim 1, wherein the NTU of the suspension is from 1600 to 2200.

10. The concentrate of claim 1, wherein the particles comprise needles and wherein the concentrate comprises no needles greater than 3 um thick.

11. A method of making a liquid beverage concentrate containing a stable suspension or one or more steviol glycosides comprising the steps of:
adding one or more steviol glycosides to an aqueous solution to provide a steviol mixture;
adjusting the pH of the steviol mixture to a pH greater than 7;
adjusting the steviol mixture, with a sufficient amount of an acidic aqueous solution, to a pH of less than about 4.0, optionally in the presence of emulsifiers, to provide a liquid beverage concentrate containing a stable suspension of one or more steviol glycoside particles having a size of about 10 um to about 80 um long and about 0.1 um to about 2.0 thick and having a concentration of at least 500 ppm.

12. The method of claim 11, wherein the pH of the steviol mixture is adjusted to a range of about 7-9.

13. The method of claim 11, wherein the NM of the suspension is from 1600 to 2200.

14. The method of claim 11, wherein the pH of the liquid beverage concentrate is in a range of about 2-4.

15. The method of claim 11, wherein the concentration of the one or more steviol glycoside particles ranges from about 1000 ppm to about 3000 ppm.

16. The method of claim 11, wherein the one or more steviol glycosides comprise rebaudioside B.

17. The method of claim 11, wherein the acidic aqueous solution is citric acid, phosphoric acid, lactic acid, tartaric acid, malic acid, and combinations thereof.

18. The method of claim 11 wherein the emulsifier is gum arabic, a monoglyceride ester, a diglyceride ester, sucrose ester, or combinations thereof.

19. The concentrate of claim 18, wherein the emulsifier is present in a concentration of about 0.1-1 wt %.

20. The method of claim 11, wherein the particles comprise needles and wherein the concentrate comprises no needles greater than 3 um thick.
